(19) United States
(12) Patent Application Publication
(10) Pub. No.: US 2023/0327450 A1
(43) Pub. Date: Oct. 12, 2023

(54) CONTROL APPARATUS, COMPUTER READABLE STORAGE MEDIUM AND METHOD

(71) Applicant: HONDA MOTOR CO.,LTD., Tokyo (JP)

(72) Inventors: Akira SAITA, Tokyo (JP); Satoshi KODO, Tokyo (JP)

(21) Appl. No.: 18/190,998

(22) Filed: Mar. 28, 2023

(30) Foreign Application Priority Data
Mar. 30, 2022 (JP) 2022-056233

(51) Int. Cl. H02J 7/00; B60L 55/00; B60L 53/62; B60L 53/63; H02J 3/32

(52) U.S. Cl. CPC H02J 3/322; B60L 53/62; B60L 53/63; B60L 55/00; H02J 7/00032; H02J 7/0013; H02J 7/005; H02J 7/00712

(57) ABSTRACT

A control apparatus, including an acquisition unit configured to acquire a usage history of a plurality of electric storage systems with a battery and an electrical appliance operating when conducting charging and discharging of the battery; and a selecting unit configured to specify a deterioration state or usage of each of the plurality of batteries and deterioration state or usage of each of the plurality of electrical appliances based on the usage history, and select, among the plurality of electric storage systems, an electric storage system that conducts power transmission and reception with the power grid according to the deterioration state or usage of each of the plurality of batteries and the deterioration state or usage of each of the plurality of electrical appliances.

### BACKGROUND

### 1. TECHNICAL FIELD

The present invention relates to a control apparatus, a computer readable storage medium and a method.

### 2. RELATED ART

In recent years, research and development has been conducted on secondary batteries that contribute to energy efficiency in order to be able to ensure that more people have access to affordable, reliable, sustainable, and advanced energy. Patent Documents 1 to 4 describe techniques related to charging and discharging of secondary batteries included in a vehicle.

### Prior Art Document

Patent Document 1: Japanese Patent No. 6918877.
Patent Document 2: Japanese Patent No. 6768080.
Patent Document 3: Japanese Patent No. 6752288.
Patent Document 4: Specification of US Pat. Application Publication No. 2015/0137752.

### BRIEF DESCRIPTION OF THE DRAWINGS

FIG. 1 conceptually illustrates a utilization form of a system 5 in an embodiment.

FIG. 2 conceptually illustrates a configuration of an electric storage system 18 included in a vehicle 10.

FIG. 3 illustrates an example of a system configuration of a control apparatus 100.

FIG. 4 illustrates information for determining margin of a battery 12 in table form.

FIG. 5 is a figure for conceptually describing an amount of electrical power output by the battery 12 during a using period of the vehicle 10.

FIG. 6 conceptually illustrates a maximum usable amount of electrical power and a reference usable amount of electrical power.

FIG. 7 is a figure for describing a process that determines whether to allow electrical power to be released from the battery 12 to a power grid 90.

FIG. 8 illustrates a state where four divided levels of the margin of the battery 12 are indexed by the vertical axis in FIG. 7.

FIG. 9 illustrates a similar notation to that in FIG. 5 for operating time of an electrical appliance 14.

FIG. 10 illustrates a table that converts an operating time margin, which is a margin related to the operating time of the electrical appliance 14, and a number of startups margin, which is a margin related to a number of startups of the electrical appliance 14 into an appliance margin.

FIG. 11 illustrates a priority of selecting the electric storage system 18 with A to D for the purpose of providing primary regulating power.

FIG. 12 illustrates a priority of selecting the electric storage system 18 for the purpose of providing tertiary regulating power.

FIG. 13 illustrates the priority information showing a priority-determining condition and the priority set in the vehicle 10 in table form.

FIG. 14 illustrates an example of a computer 2000.

### DESCRIPTION OF EXEMPLARY EMBODIMENTS

Hereinafter, embodiments of the present invention will be described, but the embodiments do not limit the invention according to the claims. In addition, not all of the combinations of features described in the embodiments are essential to the solving means of the invention.

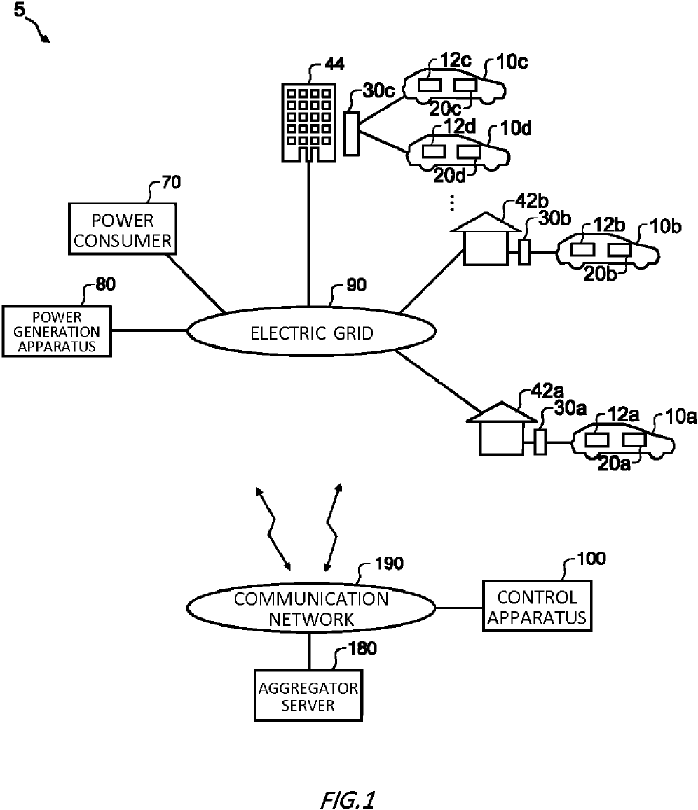

FIG. 1 conceptually illustrates a utilization form of a system 5 in an embodiment. The system 5 includes a charging and discharging facility 30a, a charging and discharging facility 30b, a charging and discharging facility 30c, a power generation apparatus 80, a control apparatus 100, a aggregator server 180, a vehicle 10a, a vehicle 10b, a vehicle 10c and a vehicle 10d.

The vehicle 10a, the vehicle 10b, the vehicle 10c and the vehicle 10d respectively includes a battery 12a, a battery 12b, a battery 12c and a battery 12d. The vehicle 10a, the vehicle 10b, the vehicle 10c and the vehicle 10d respectively includes a control apparatus 20a, a control apparatus 20b, a control apparatus 20c and a control apparatus 20d. In this embodiment, the vehicle 10a, the vehicle 10b, the vehicle 10c and the vehicle 10d may be collectively referred to as a “vehicle 10”. The battery 12a, the battery 12b, the battery 12c and the battery 12d may be collectively referred to as a “battery 12”. The control apparatus 20a, the control apparatus 20b, the control apparatus 20c and the control apparatus 20d may be collectively referred to as a “control apparatus 20”. The charging and discharging facility 30a, the charging and discharging facility 30b, the charging and discharging facility 30c may be collectively referred to as a “charging and discharging facility 30”.

The control apparatus 100 is connected to the aggregator server 180 through a communication network 190. The control apparatus 100 can communicate with the charging and discharging facility 30 through the communication network 190. The control apparatus 100 controls the charging and discharging facility 30 through the communication network 190. The control apparatus 100 communicates with the control apparatus 20 of the vehicle 10 through the communication network 190, and acquires various of information of the vehicle 10, including travelling history, as well as SOC and SOH of the battery 12 of the vehicle 10.

The charging and discharging facility 30, a power consumer 70 and the power generation apparatus 80 are connected to a power grid 90. The power generation apparatus 80 includes, for example, a power plant operated by an electric power utility company. The electrical power generated by the power generation apparatus 80 can be supplied to the charging and discharging facility 30 and the power consumer 70 through the power grid 90. The power grid 90 is, for example, an electrical power system.

Each of the charging and discharging facilities 30 conducts charging and discharging of the battery 12 mounted on the vehicle 10 that is respectively connected thereto. The vehicle 10 is, for example, an electric vehicle. The battery 12 is a battery for supplying electrical power for travelling of the vehicle 10. The vehicle 10 may be a privately owned vehicle, a vehicle used by a business man for business, a shared car and so on.

The charging and discharging facility 30a is provided in a dwelling unit 42a, and conducts charging and discharging of the battery 12a of the vehicle 10a connected to the charging and discharging facility 30a. When the battery 12a has conducted discharging, the electrical power provided from the battery 12a may be consumed by an electric power load inside the dwelling unit 42a, or may be provided to the power grid 90 through a power line disposed in the dwelling unit 42a. The charging and discharging facility 30b is provided in a dwelling unit 42b, and conducts charging and discharging of the battery 12b of the vehicle 10b connected to the charging and discharging facility 30b. When the battery 12b has conducted discharging, the electrical power provided from the battery 12b is consumed by an electric power load inside the dwelling unit 42b, or provided to the power grid 90 through a power line disposed in the dwelling unit 42b. The charging and discharging facility 30c is a charging and discharging facility provided in a facility 44, and conducts charging and discharging of the battery 12c and the battery 12d mounted on the vehicle 10c and the vehicle 10d that are connected to the charging and discharging facility 30c. When the battery 12c and the battery 12d have conducted discharging, the electrical power provided from the battery 12c and the battery 12d may be consumed by an electric power load inside the facility 44, or may be provided to the power grid 90 through a power line disposed in the facility 44.

Each of the charging and discharging facilities 30 can charge the battery 12 with the electrical power received from the power grid 90. The charging and discharging facility 30 can cause the battery 12 to discharge and transmit the power to the power grid 90.

When conducting transmission and reception of the electrical power between the power grid 90 and the battery 12, the charging and discharging facility 30 and the control apparatus 20 of the vehicle 10 conduct charging and discharging of the battery 12 according to the control of the control apparatus 100. For example, the control apparatus 100 can instruct the charging and discharging facility 30 and the control apparatus 20 to discharge the battery 12 when there occurs a power shortage in the power grid 90, thereby causing the battery 12 to transmit power to the power grid 90. The control apparatus 100 can instruct the charging and discharging facility 30 and the control apparatus 20 to charge the battery when there occurs power surplus in the power grid 90, thereby mitigating the power surplus in the power grid 90. In this manner, the control apparatus 100 can collaborate with the control apparatus 100, the charging and discharging facility 30 and the control apparatus 20 to provide a primary regulating power, a secondary regulating power, a tertiary regulating power and so on in the power grid 90. This allows the control apparatus 100 to aggregate a plurality of batteries 12 mounted on a plurality of vehicles 10 to provide a power resource to the power grid 90.

The aggregator server 180 is, for example, a server used by an electrical power aggregator. The aggregator server 180 conducts electrical power transactions in the electrical power market. The control apparatus 100 communicates with the aggregator server 180, and provides a required amount of electrical power to the power grid 90. For example, the control apparatus 100 controls the charging and discharging facility 30 and the control apparatus 20 to charge and discharge the battery 12 according to the demand from the aggregator server 180 to provide electrical power in an amount according to the demand.

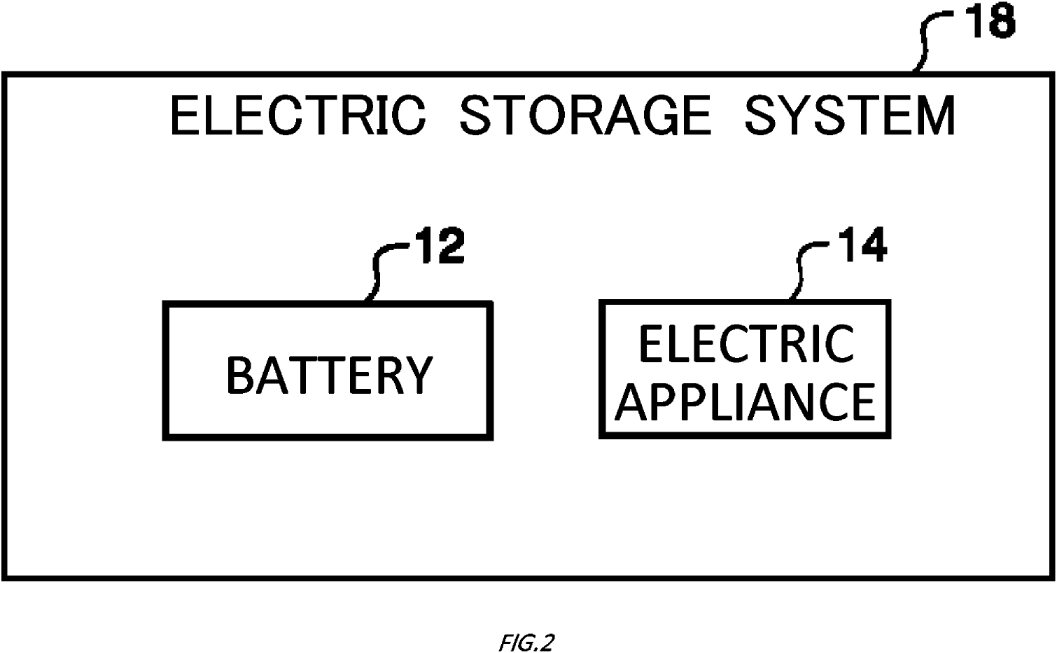

FIG. 2 conceptually illustrates a configuration of an electric storage system 18 included in the vehicle 10. The electric storage system 18 includes a battery 12 and an electrical appliance 14. The electrical appliance 14 is an electrical appliance required to operate in order to allow the battery 12 to conduct charging and discharging. The electrical appliance 14 includes an electrical component such as a relay, a switch, and a DC-DC converter, a control appliance such as an ECU (Electronic Control Unit), and a communication appliance such as a TCU (Telematics Control Unit). The electrical appliance 14 includes at least a part of the control apparatus 20.

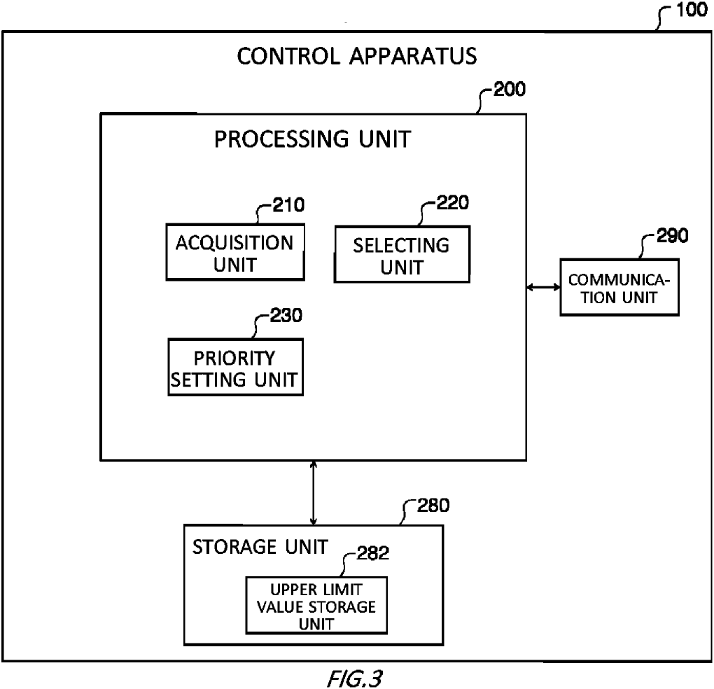

FIG. 3 illustrates an example of a system configuration of the control apparatus 100. The control apparatus 100 includes a processing unit 200, a storage unit 280 and a communication unit 290.

The processing unit 200 conducts control on the communication unit 290. The communication unit 290 is responsible for the communication between the aggregator server 180 and the vehicle 10. The processing unit 200 is achieved by an operation processing apparatus including a processor. The storage unit 280 is respectively achieved by including a non-volatile storage medium. The processing unit 200 conducts processing by using information stored in the storage unit 280. The processing unit 200 may be achieved by a micro computer including a CPU, a ROM, a RAM, an I/O, a bus and so on. The control apparatus 100 may be achieved by a computer.

In this embodiment, the control apparatus 100 is achieved by a single computer. However, in another embodiment, the control apparatus 100 may be achieved by a plurality of computers. At least a part of the functionality of the control apparatus 100 may be achieved by one or more servers such as a cloud server.

The processing unit 200 includes an acquisition unit 210, a selecting unit 220 and a priority setting unit 230. The storage unit 280 includes an upper limit value storage unit 282.

The acquisition unit 210 acquires a usage history of a plurality of electric storage systems 18 that allow charging and discharging of the electrical power with the power grid 90. The selecting unit 220 selects, among the plurality of electric storage systems 18, an electric storage system 18 that conducts power transmission and reception with the power grid 90. Each of the plurality of electric storage systems 18 includes a battery 12, an electrical appliance 14 that operates when conducting charging and discharging of the battery 12. Based on the usage history, the selecting unit 220 specifies the deterioration state or usage of each of the plurality of batteries 12 and the deterioration state or usage of each of the plurality of electrical appliances 14, and selects, among the plurality of electric storage systems 18, an electric storage system 18 that conducts power transmission and reception with the power grid 90, according to the deterioration state or usage of each of the plurality of batteries 12 and the deterioration state or usage of each of the plurality of electrical appliances 14.

The selecting unit 220 selects, among the plurality of electric storage systems 18, an electric storage system 18 that conducts power transmission and reception with the power grid 90 by conducting charging and discharging in a first manner, which largely affects the deterioration of the plurality of electrical appliances 14, and an electric storage system 18 that conducts power transmission and reception with the power grid 90 by conducting charging and discharging in a second manner, which largely affects the deterioration of the plurality of batteries 12.

The selecting unit 220 gives, among the plurality of electric storage systems 18, more priority to the electric storage system 18 including a battery 12 with greater deterioration state or usage, and selects it as the electric storage system 18 that conducts power transmission and reception with the power grid 90 by conducting charging and discharging in the first manner.

The selecting unit 220 gives, among the plurality of electric storage systems 18, more priority to the electric storage system 18 including an electrical appliance 14 with greater deterioration state or usage, and selects it as the electric storage system 18 that conducts power transmission and reception with the power grid 90 by conducting charging and discharging in the second manner.

When the power resource provided by the electric storage system 18 that conducts power transmission and reception with the power grid 90 is insufficient to the power resource required in the power grid 90, the selecting unit 220 further selects, among the plurality of electric storage systems 18, the electric storage system 18 including a battery 12 with the deterioration degree or usage being equal to or greater than a predetermined first threshold and an electrical appliance 14 with the deterioration degree or usage being equal to or greater than a second threshold, as the electric storage system 18 that conducts power transmission and reception with the power grid 90.

The selecting unit 220 does not select, among the plurality of electric storage systems 18, the electric storage system 18 including a battery 12 with the deterioration degree or usage being equal to or greater than a predetermined third threshold, or an electrical appliance 14 with the deterioration degree or usage being equal to or greater than a fourth threshold, as the electric storage system 18 that conducts power transmission and reception with the power grid 90.

The upper limit value storage unit 282 stores the upper limit value of the deterioration degree or usage of each of the plurality of batteries 12 at a predetermined time point, and the upper limit value of the deterioration degree or usage of each of the plurality of electrical appliances 14 at a predetermined time point. The selecting unit 220 specifies, based on the deterioration degree of the usage of each of the plurality of batteries 12 and the upper limit value of the deterioration degree or usage of each of the plurality of batteries 12, the margin of the deterioration degree or usage of each of the plurality of batteries 12 for the upper limit value of the deterioration degree or usage of each of the plurality of batteries 12, and specifies, based on the deterioration state or usage of each of the plurality of electrical appliances 14 and the upper limit value of the deterioration degree or usage of each of the plurality of electrical appliances 14, the margin of the deterioration degree or usage of each of the plurality of electrical appliances 14 for the upper limit value of the deterioration degree or usage of each of the plurality of electrical appliances 14, and selects, among the plurality of electric storage systems 18, the electric storage system 18 that conducts power transmission and reception with the power grid 90 according to the margin of the deterioration degree or usage of each of the plurality of batteries 12 as well as the margin of the deterioration degree or usage of each of the plurality of electrical appliances 14.

The selecting unit 220 specifies the deterioration state or usage of each of the plurality of batteries 12 and the deterioration state or usage of each of the plurality of electrical appliances 14 during a predetermined period, and updates the deterioration state or usage of each of the plurality of batteries 12 and the deterioration state or usage of each of the plurality of electrical appliances 14 when the predetermined period elapses.

Each electric storage system 18 of the plurality of electric storage systems 18 is provided in one corresponding vehicle 10 among a plurality of vehicles 10. The priority setting unit 230 sets a high priority to a vehicle 10 that satisfies a predetermined first condition rather than a vehicle 10 that does not satisfy the first condition among the plurality of vehicles 10. The selecting unit 220 gives more priority to and selects, among the plurality of electric storage systems 18 included in the plurality of vehicles 10, the electric storage system 18 included in the vehicle 10 with a higher priority as the electric storage system 18 that conducts power transmission and reception with the power grid 90.

The priority setting unit 230 sets a high priority to the vehicle 10 associated with a user who is subscribed to a predetermined service related to the vehicle 10, rather than a vehicle 10 associated with a user who is not subscribed to the predetermined service.

The priority setting unit 230 sets a high priority to the vehicle 10 including an electric storage system 18 such that the number of times of being selected, by the selecting unit 220 during the predetermined period, as the electric storage system 18 that conducts power transmission and reception with the power grid 90 is lower than a predetermined selection lower limit value, rather than a vehicle 10 including an electric storage system 18 such that the number of times of being selected, by the selecting unit 220 during the predetermined period, as the electric storage system 18 that conducts power transmission and reception with the power grid 90 is equal to or greater than the selection lower limit value.

The priority setting unit 230 sets a high priority to the vehicle 10 including an electric storage system 18 such that the number of times of being selected, by the selecting unit 220 during the predetermined period, as the electric storage system 18 that conducts power transmission and reception with the power grid 90 is lower than a predetermined selection target value, rather than a vehicle 10 including an electric storage system 18 such that the number of times of being selected, by the selecting unit 220 during the predetermined period, as the electric storage system 18 that conducts power transmission and reception with the power grid 90 is equal to or greater than the selection target value.

Furthermore, the priority setting unit 230 temporarily sets a high priority to the vehicle 10 that satisfies a predetermined second condition, which should be satisfied by a vehicle 10 with a temporarily set high priority, rather than a vehicle 10 that does not satisfy the second condition.

The priority setting unit 230 temporarily sets a high priority to a vehicle 10 associated with a user who has participated in a predetermined temporary campaign rather than a vehicle 10 associated with a user who has not participated in the campaign.

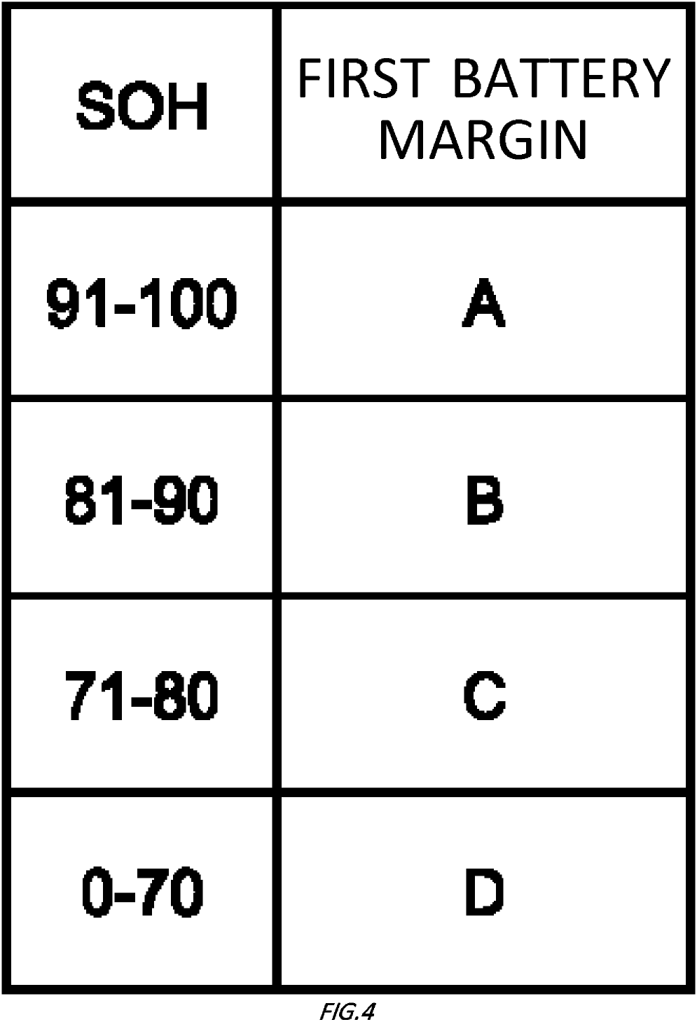

FIG. 4 illustrates the information for determining the margin of the battery 12 in table form. The selecting unit 220 determines the margin of the battery based on the SOH (State of health) of the battery 12.

The SOH is also referred to as the state of health. The SOH may be expressed as the rate of capacitance retention or the rate of increase in internal resistance. In this embodiment, the SOH is regarded as the information indicating the low degree of the deterioration degree of the battery 12.

The SOH is an example of the information representing the deterioration state of the battery 12. Typically, the SOH decreases as the battery 12 is used for charging and discharging. Therefore, the SOH can also be regarded as the information representing the usage of the battery.

The selecting unit 220 determines the first battery margin of the battery 12 with the SOH being from 91% to 100% as A. The selecting unit 220 determines the first battery margin of the battery 12 with the SOH being from 81% to 90% as B. The selecting unit 220 determines the first battery margin of the battery 12 with the SOH being from 71% to 80% as C. The selecting unit 220 determines the first battery margin of the battery 12 with the SOH being 0% to 70% as D.

The first battery margin A to D represents the lower deterioration degree of the battery 12 in the order of A, B, C and D. The first battery margin A to D represents the lower usage of the battery 12 in the order of A, B, C and D.

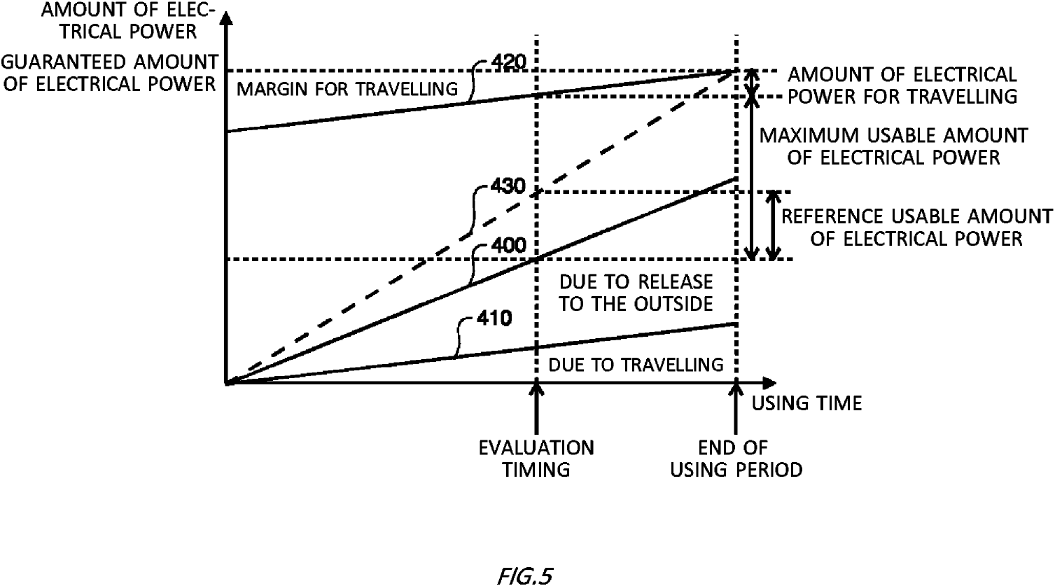

Then a determination method of a second battery margin is described with FIG. 5 to FIG. 8.

FIG. 5 is a figure for conceptually describing the amount of electrical power output by the battery 12 during the using period of the vehicle 10. In the graph of FIG. 5, the horizontal axis is the time, and the vertical axis is the amount of electrical power. The point of origin of the horizontal axis is, for example, the time of shipping of the vehicle 10. The vertical axis is regarded to represent the discharged amount of electrical power of the battery 12. In this embodiment, the control apparatus 100 controls the charging and discharging of the battery 12 so that the amount of electrical power output by the battery 12 from the start of use to the end of a designated using period of the vehicle 10 becomes equal to or lower than a predetermined guaranteed amount of electrical power. The guaranteed amount of electrical power is the amount of electrical power actually guaranteed, output by the battery 12, during the using period. The guaranteed amount of electrical power may be a predetermined value. The guaranteed amount of electrical power may be stored in the upper limit value storage unit 282.

In FIG. 5, a line 400 indicates the entire amount of electrical power output from the battery 12. A line 410 indicates the amount of electrical power output from the battery 12 due to the travelling of the vehicle 10 (due to travelling). The difference between the line 400 and the line 410 indicates the amount of electrical power output from the battery 12 due to operations other than travelling of the vehicle 10. In the present embodiment, the difference between the line 400 and the line 410 indicates the amount of electrical power released from the battery 12 to the power grid 90 outside the vehicle 10 (due to release to the outside).

A line 420 indicates the amount of electrical power that should be reserved for the future travelling of the vehicle 10 in the guaranteed amount of electrical power that can be output by the battery 12 (margin for travelling). A line 430 indicates an assumed amount of electrical power when the battery 12 is averagely used so that the electrical power in the guaranteed amount of electrical power is output from the battery 12 from the start of use to the end of the using period of the vehicle 10. That is, if the battery 12 is used along the line 430, the cumulative amount of electrical power output by the vehicle 10 from the start of use to the end of the using period of the vehicle 10 will match the guaranteed amount of electrical power. The reference information indicating the line 430 is stored in the storage unit 280.

The control apparatus 100 calculates the total output amount of electrical power due to travelling output from the battery 12 from the start of use to the end of the using period of the vehicle 10, which occurs due to the travelling of the vehicle 10. The control apparatus 100 may calculate the total output amount of electrical power due to travelling by extrapolating, up to the end of the using period, the amount of electrical power output from the battery 12 due to the travelling of the vehicle 10 from the start of use of the vehicle 10 to the current time. The total output amount of electrical power due to travelling is the sum of the amount of electrical power output from the battery 12 due to the travelling of the vehicle 10 up to the current time and the amount of electrical power for travelling in FIG. 5. The amount of electrical power for travelling in FIG. 5 represents the output amount of electrical power that is predicted to occur due to the travelling of the vehicle 10 from the current time to the end of the using period.

The control apparatus 100 calculates the maximum usable amount of electrical power at a current evaluation timing. The maximum usable amount of electrical power is calculated by subtracting from the guaranteed amount of electrical power the sum of the total output amount of electrical power due to travelling and the amount of electrical power output from the battery 12 to the power grid 90 up to the current time. The maximum usable amount of electrical power corresponds to the maximum value that can be output from the battery 12 to the power grid 90 until the end of the using period of the vehicle 10.

The control apparatus 100 calculates the reference usable amount of electrical power at the current evaluation timing. First, the control apparatus 100 calculates reference amount of electrical power at the current time referring to the reference information. The reference amount of electrical power at the current time is a value on the line 430 at the current time. The reference usable amount of electrical power is calculated by subtracting from the reference amount of electrical power the amount of electrical power output from the battery 12 due to the travelling of the vehicle 10 up to the current time and the amount of electrical power output from the battery 12 to the power grid 90 up to the current time. The control apparatus 100 may restrict the charging and discharging of the battery 12 based on at least one of the maximum usable amount of electrical power or the reference usable amount of electrical power.

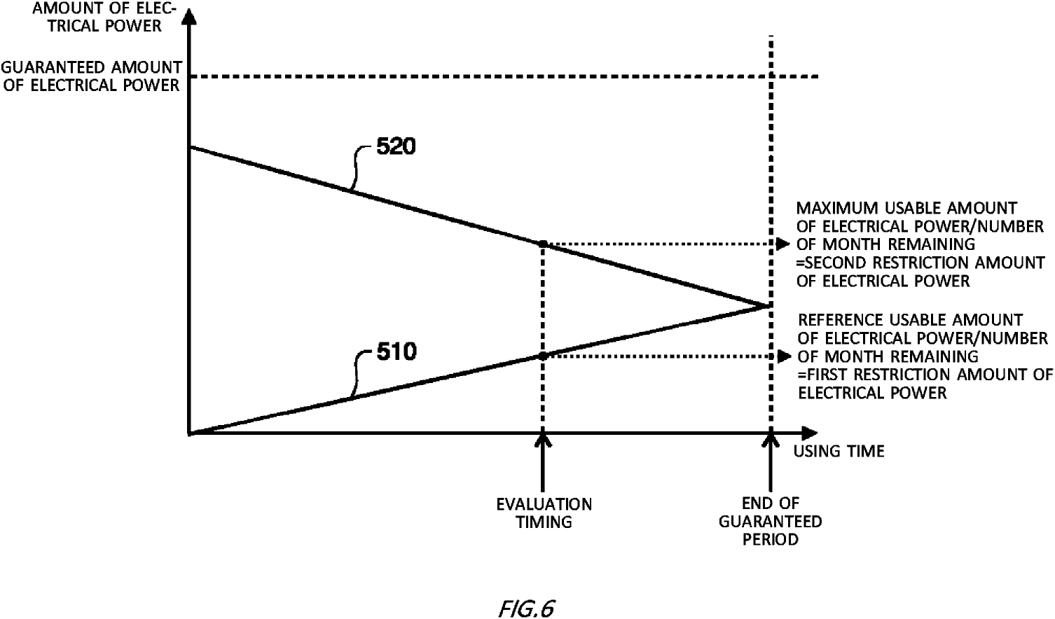

FIG. 6 conceptually illustrates a maximum usable amount of electrical power and a reference usable amount of electrical power. In FIG. 6, a line 520 represents the maximum usable amount of electrical power, and a line 510 represents the reference usable amount of electrical power.

The control apparatus 100 calculates a second restriction amount of electrical power by dividing the currently evaluated maximum usable amount of electrical power by the number of months remaining until the end of the using period. The second restriction amount of electrical power corresponds to a maximum amount of electrical power allowable to be output from the battery 12 to the power grid 90 per month. If the amount of electrical power output from the battery 12 to the power grid 90 per month exceeds the second restriction amount of electrical power, the amount of electrical power output by the battery 12 may exceed the guaranteed amount of electrical power until the end of the using period. Therefore, the control apparatus 100 controls the charging and discharging of the battery 12 so that the amount of electrical power output from the battery 12 to the power grid 90 per month does not exceed the second restriction amount of electrical power.

The control apparatus 100 calculates a first restriction amount of electrical power by dividing the reference usable amount of electrical power at the current time by the number of months remaining until the end of the using period. If the amount of electrical power output from the battery 12 to the power grid 90 per month exceeds the first restriction amount of electrical power, the line 430 in FIG. 5 will be exceeded. Therefore, the control apparatus 100 controls the charging and discharging of the battery 12 so that the amount of electrical power output from the battery 12 to the power grid 90 per month does not exceed the first restriction amount of electrical power as possible.

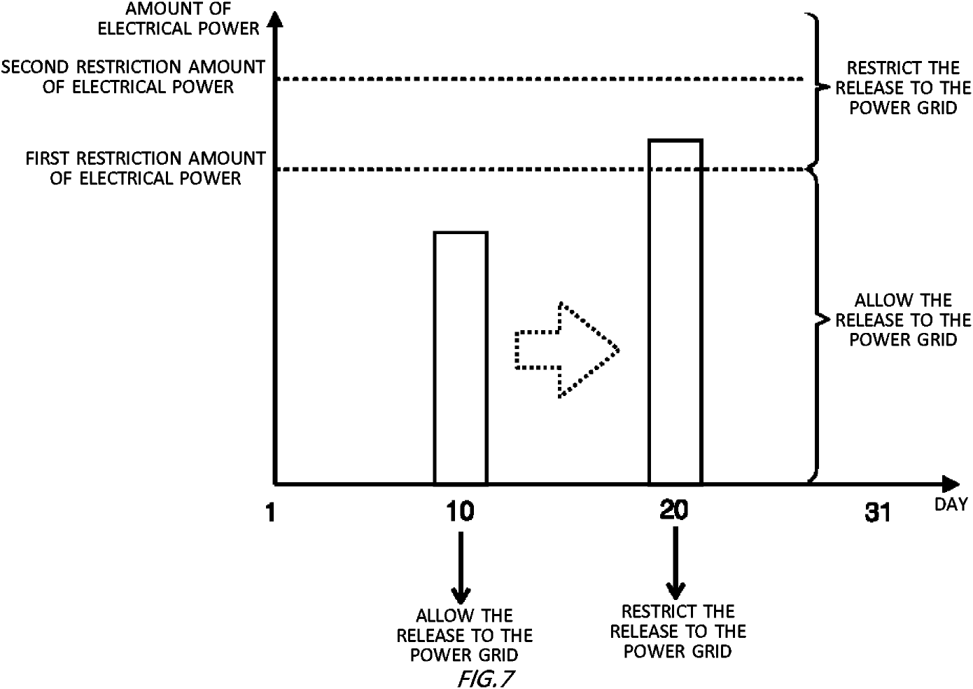

FIG. 7 is a figure for describing a process for determining whether to allow to release electrical power from the battery 12 to the power grid 90. The vertical axis of FIG. 7 represents the amount of electrical power released from the battery 12 to the power grid 90 within one month. The horizontal axis represents the number of days in one month. In the example illustrated in FIG. 7, the released amount of electrical power released from the battery 12 to the power grid 90 during one day to 10 days is less than the first restriction amount of electrical power. Therefore, in the step of 10 days, it can be determined that there is a margin for further releasing electrical power by the battery 12 to the power grid 90. Therefore, the control apparatus 100 determines to allow to release the electrical power from the battery 12 to the power grid 90 (allow the release to the power grid).

On the other hand, the released amount of electrical power released from the battery 12 to the power grid 90 during one day to 20 days exceeds the first restriction amount of electrical power at the 20th day. Therefore, the control apparatus 100 restrict the release of the electrical power from the battery 12 to the power grid 90 (restrict the release to the power grid). In the present embodiment, the selecting unit 220 of the control apparatus 100 regards the battery 12 with the released amount of electrical power exceeding the first restriction amount of electrical power as not to be selected as the battery to release electrical power to the power grid 90. In another embodiment, the selecting unit 220 may select, as the battery to release electrical power to the power grid 90, a battery with the released amount of electrical power not exceeding the second restriction amount of electrical power, even if the released amount of electrical power exceeding the first restriction amount of electrical power.

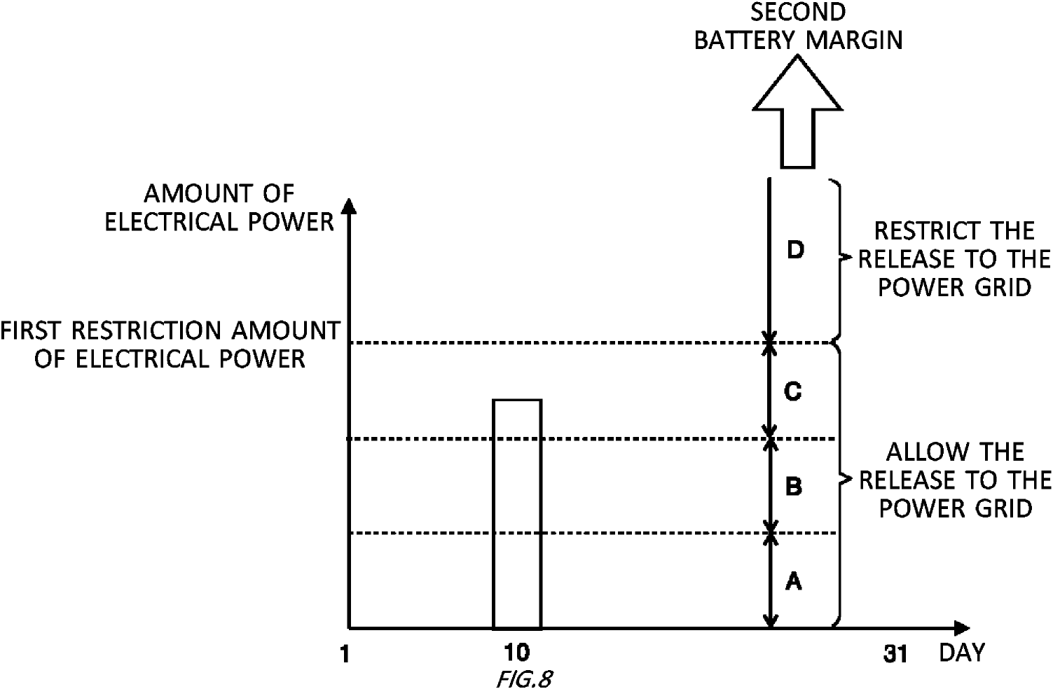

FIG. 8 illustrates a state where four divided levels of the margin of the battery 12 are indexed by the vertical axis in FIG. 7. Similar to FIG. 7, the vertical axis in FIG. 8 is the amount of electrical power released to the power grid 90 within one month, and the horizontal axis is the number of days in one month. In FIG. 8, the amount of electrical power released from the battery 12 to the power grid 90 during one day to 10 days is illustrated.

In FIG. 8, the range where the released amount of electrical power is equal to or less than the first restriction amount of electrical power is divided into three levels of level A, B and C, and the range where the released amount of electrical power exceeds the first restriction amount of electrical power is regarded as level D. As shown in FIG. 8, in the step of 10 days in one month, the battery 12 is classified as level C.

Among level A, B, C and D, the battery 12 belonging to level A can be regarded to have the largest margin for releasing the electrical power to the power grid 90. The following levels B, C and D, in that order, can be regarded to have the highest margin for releasing the electrical power to the power grid 90. Therefore, in this embodiment, A, B, C and D are selected as the second battery margin. The selecting unit 220 may update the margin by using information of the past one month acquire by the acquisition unit 210 each time a month or a predetermined number of days have elapsed.

The control apparatus 100 uses the first battery margin described associated with FIG. 4, or the second battery margin described associated with FIG. 5 as a battery margin.

Then, the determination method of the margin of the electrical appliance 14 is to be described.

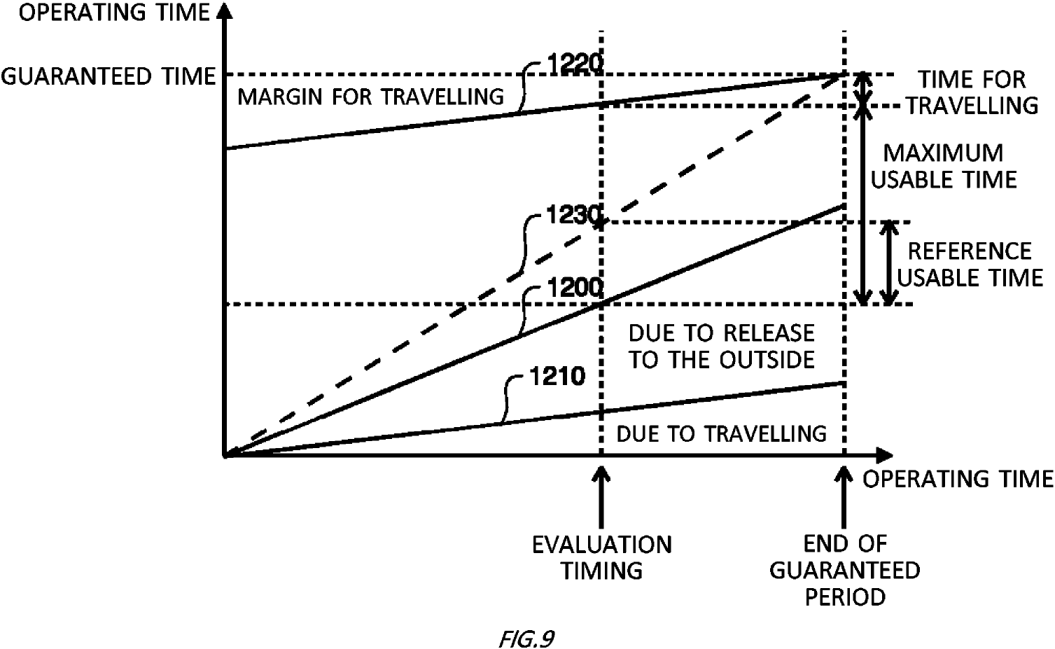

FIG. 9 illustrates a similar notation to that in FIG. 5 for operating time of an electrical appliance 14. In the description of FIG. 9, the description about the points similar to those described associated with FIG. 5 may be omitted. Note that for example, the operating time of the control appliance or the communication appliance included in the electrical appliance 14, the operating time of components such as a DC-DC converter and so on can be applied as the operating time of the electrical appliance 14.

In the graph of FIG. 9, the horizontal axis is the time, the vertical axis is operating time. The point of origin of the horizontal axis is, for example, the time of shipping of the vehicle 10. The vertical axis is regarded to represent the operating time of the electrical appliance 14. In this embodiment, the control apparatus 100 controls the charging and discharging of the battery 12 so that the operating time of the electrical appliance 14 from the start of use to the end of a designated using period of the vehicle 10 becomes to be equal to or less than a predetermined guaranteed time. The guaranteed time is the time when the operation of the electrical appliance 14 is actually guaranteed during the using period. The guaranteed time may be a predetermined value. The guaranteed time may be stored in the upper limit value storage unit 282.

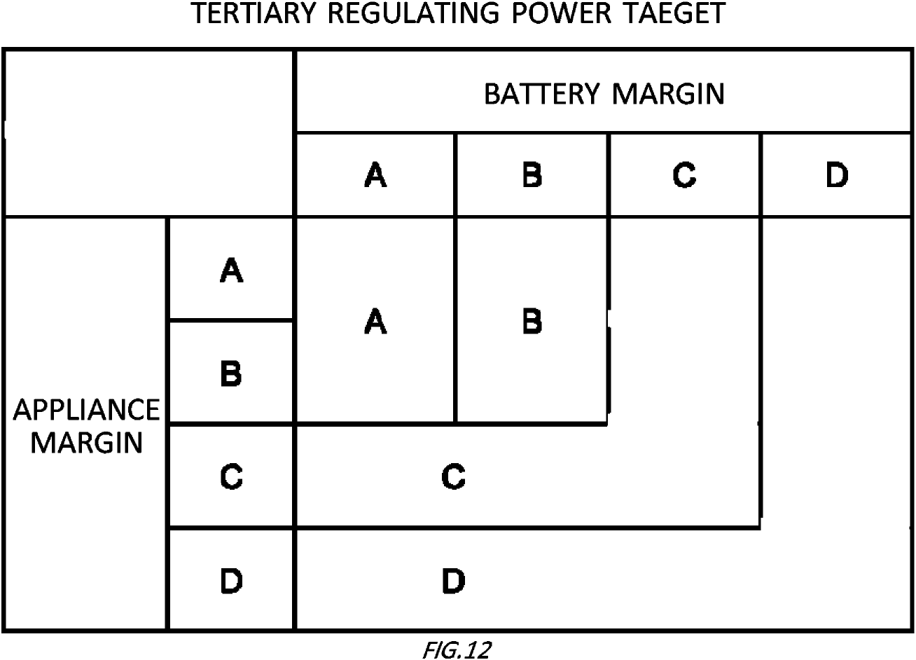

In FIG. 12, the line 1200 indicates the entire operating time when the electrical appliance 14 is in operation. The difference between the line 1210 and the line 1200 indicates the operating time of the electrical appliance 14 due to the operations other than travelling of the vehicle 10. The line 1210 indicates the operating time of the electrical appliance 14 due to the travelling of the vehicle 10 (due to travelling). In the present embodiment, the difference between the line 1200 and the line 1210 indicates the operating time of the electrical appliance 14 occurred due to conducting the operation of releasing the electrical power from the battery 12 to the power grid 90 outside the vehicle 10 (due to release to the outside).

The line 1220 indicates the time that should be reserved for future travelling of the vehicle 10 in the guaranteed time when the electrical appliance 14 is operatable (margin for travelling). The line 1230 indicates the assumed operating time when the electrical appliance 14 is averagely used so that the electrical appliance 14 only operates during the guaranteed operating time from the start of use to the end of the using period of the vehicle 10. That is, if the battery 12 is used along the line 1230, the cumulative operating time of the electrical appliance 14 from the start of use to the end of the using period of the vehicle 10 becomes to match with guaranteed electrical power time. The reference information indicating the line 1230 is stored in the storage unit 280.

The control apparatus 100 calculates the operating time due to travelling, which occurs due to the travelling of the vehicle 10, which is the operating time of the electrical appliance 14 from the start of use to the end of the using period of the vehicle 10. The control apparatus 100 may calculate the operating time due to travelling by extrapolating until the end of the using period, by the electrical appliance 14, the operating time that occurs due to the travelling of the vehicle 10 from the start of use of the vehicle 10 to the current time. The operating time due to travelling is the sum of the operating time of the electrical appliance 14 due to the travelling of the vehicle 10 up to the current time, and the time for travelling in FIG. 9. The time for travelling in FIG. 9 indicates the operating time of the electrical appliance 14 that is predicted to occur due to the travelling of the vehicle 10 from the current time to the end of the using period.

The control apparatus 100 calculates maximum usable time at the current evaluation timing. The maximum usable time is calculated by subtracting from the guaranteed time the sum of the operating time due to travelling and the operating time of the electrical appliance 14 up to the current time. The maximum usable time corresponds to the maximum value that the electrical appliance 14 can operate until the end of the using period of the vehicle 10.

The control apparatus 100 calculates usable reference time at the current evaluation timing. First, the control apparatus 100 calculates the reference operating time at the current time referring to the reference information. The reference operating time at the current time is the value on the line 1230 at the current time. The usable reference time is calculated by subtracting from the reference time the operating time of the electrical appliance 14 up to the current time. The control apparatus 100 may restrict the charging and discharging of the battery 12 based on at least one of the maximum usable time or the usable reference time.

As described above, the maximum usable time corresponding the maximum usable amount of electrical power and the usable reference time corresponding to the usable reference time described associated with FIG. 5 can be calculated based on the operating time of the electrical appliance 14. Accordingly, by using the approach similar to the approach described associated with FIG. 5 to FIG. 8, the level classification of the margin related to the operating time of the electrical appliance 14 can be conducted. In this embodiment, the control apparatus 100 calculates the margin related to the operating time of the electrical appliance 14 by four levels of A, B, C and D. Furthermore, the control apparatus 100 calculates, similar to the operating time of the electrical appliance 14, the margin related to the number of startups of the electrical appliance 14 by four levels of A, B, C and D. Note that for example, the number of startups of the control appliance or the communication appliance included in the electrical appliance 14, the number of times of operation of components such as a DC-DC converter and so on can be applied as the number of startups of the electrical appliance 14.

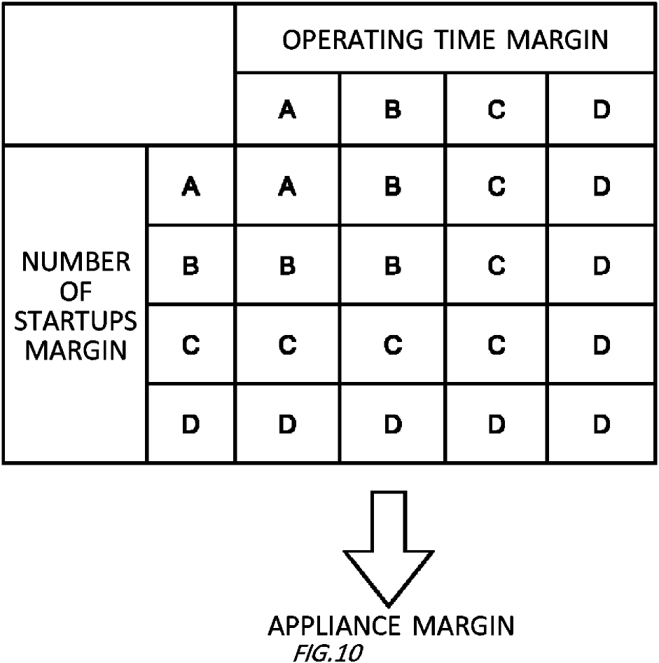

FIG. 10 illustrates a table that converts an operating time margin, which is a margin related to the operating time of the electrical appliance 14, and a number of startups margin, which is a margin related to a number of startups of the electrical appliance 14 into an appliance margin. The table in FIG. 10 illustrates the corresponding relationship between the combination of the levels of A to C of the operating time margin and the levels of A to C of the number of startups margin, and the levels of A to C of the appliance margin. As shown in FIG. 10, the control apparatus 100 determines the one with a lower level of the operating time margin and the number of startups margin as the appliance margin.

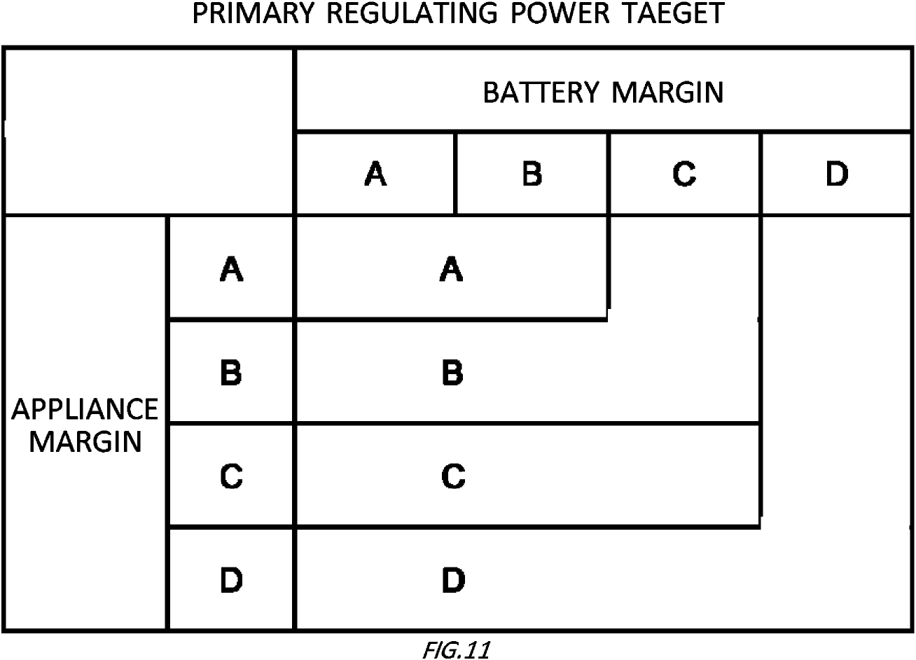

FIG. 11 illustrates the priority for selecting the electric storage system 18 for the purpose of providing a primary regulating power by A to D. As shown in FIG. 11, the priority is determined for selecting, from the combination of the battery margin and the appliance margin, the electric storage system 18 for the purpose of providing the primary regulating power. Either of the first battery margin or the second battery margin described above is applied to the battery margin.

FIG. 11 illustrates that the electric storage system 18 determined to have priority A is given more priority than the electric storage system 18 determined to have priority B, and is caused to corresponds to the primary regulating power. The electric storage system 18 determined to have priority C is regarded to be selected only when the electric storage system 18 caused to be correspond to the primary regulating power is insufficient. The electric storage system 18 determined to have priority D is not selected even if the electric storage system 18 caused to correspond to the primary regulating power is insufficient.

FIG. 12 illustrates the priority for selecting the electric storage system 18 for the purpose of providing a tertiary regulating power. As shown in FIG. 12, the priority for selecting, from the combination of the battery margin and the appliance margin, the electric storage system 18 is determined for the purpose of providing the tertiary regulating power.

FIG. 12 illustrates that the electric storage system 18 determined to have priority A is given more priority than the electric storage system 18 determined to have priority B, and is caused to corresponds to the tertiary regulating power. The electric storage system 18 determined to have priority C is regarded to be selected only when the electric storage system 18 caused to be correspond to the tertiary regulating power is insufficient. The electric storage system 18 determined to have priority D is not selected even if the electric storage system 18 caused to correspond to the tertiary regulating power is insufficient.

Compared to the tertiary regulating power, since the amount of electrical power required to provide the primary regulating power is less, even the electrical appliance 14 including the battery 12 with a low battery margin can correspond to the primary regulating power. On the other hand, since there comes a need to correspond to the primary regulating power continuously, the impact on the durability or life of the electrical appliance 14 may become significant. Therefore, as shown in FIG. 11, the selecting unit 220 gives more priority to and selects the electric storage system 18 including the electrical appliance 14 with an appliance margin of A as the electric storage system 18 that should correspond to the primary regulating power, even if the electric storage system 18 includes a battery 12 with a battery margin of B. Also, even if the electric storage system 18 includes the battery 12 with a battery margin of A, if the appliance margin of its electrical appliance 14 is B, the priority for corresponding to the primary regulating power is regarded as B.

In contrast, compared to the primary regulating power, since the amount of electrical power required to provide the tertiary regulating power is large, the impact on the durability or the life of the battery 12 is significant. On the other hand, since there is no need to correspond to the tertiary regulating power continuously, even the electrical appliance 14 including the electrical appliance 14 with a low appliance margin may be able to correspond to the tertiary regulating power. Therefore, as shown in FIG. 12, the selecting unit 220 gives more priority to and selects the electric storage system 18 including the electrical appliance 14 with a battery margin of A as the electric storage system 18 that should correspond to the tertiary regulating power, even if the electric storage system 18 includes a battery 12 with a appliance margin of B. Also, even if the electric storage system 18 includes the electrical appliance 14 with an appliance margin of A, if the battery margin of its battery 12 is B, the priority for corresponding to the tertiary regulating power is regarded as B.

In this manner, the selecting unit 220 can cause the electric storage system 18 to provide appropriate regulating power of the primary regulating power and the tertiary regulating power according to the combination of the battery margin and the appliance margin in the electric storage system 18. This enables the averaging of the impact on the durability of the electric storage system 18.

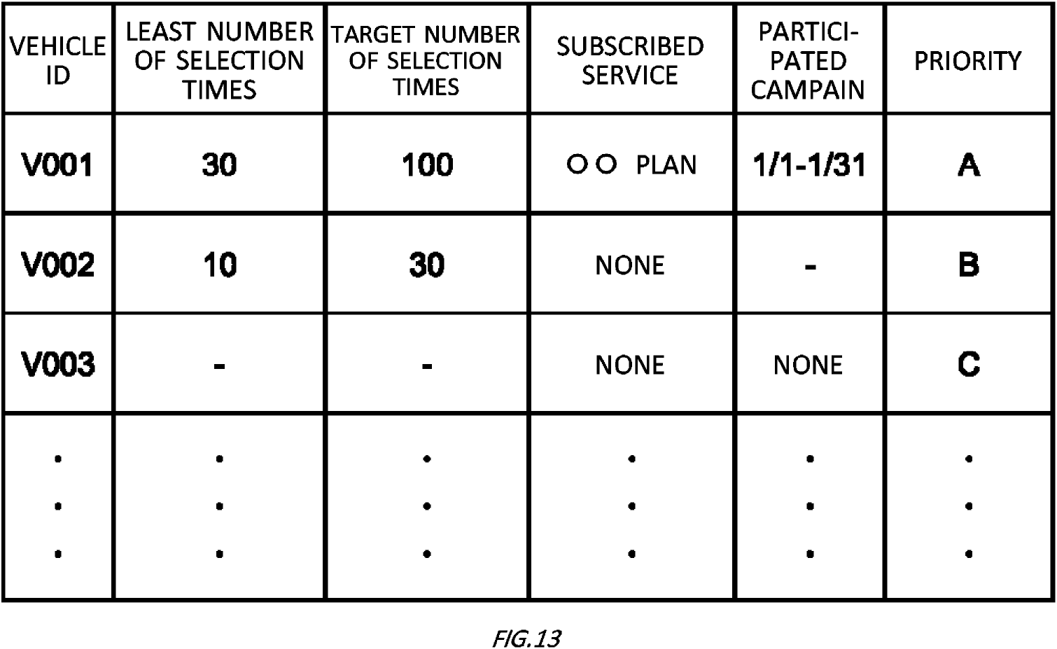

FIG. 13 illustrates the priority information showing the priority-determining condition and the priority set in the vehicle 10 in table form. The priority information is stored in the storage unit 280.

The priority information associates the vehicle ID, the least number of selection times, the target number of selection times, the subscribed service, the participated campaign and the priority. The vehicle ID is the identification information of the vehicle 10. The least number of selection times indicates the number of times of being selected, as the electric storage system 18 that conducts the transmission and reception of the electrical power with the power grid 90 per month. The target number of selection times indicates the target number of times of being selected, as the electric storage system 18 that conducts the transmission and reception of the electrical power with the power grid 90 per month. The subscribed service is a paid service to which the user associated with the vehicle 10 is subscribed. The participated campaign shows the period of temporary participation in the campaign of the user associated with the vehicle 10.

The priority indicates the priority calculated based on the least number of selection times, the target number of selection times, the subscribed service and the participated campaign, as well as the number of selected times N of being selected as the electric storage system 18 that conducts the transmission and reception of the electrical power with the power grid 90 during the past one month. In FIG. 13, A indicates the highest priority, and C indicates the lowest priority.

For example, the priority setting unit 230 may calculate the priority based on the sum of the evaluation value determined from the difference between the least number of selection times and the number of selected times N, the evaluation value determined from the difference between the target number of selection times and the number of selected times N, the evaluation value determined from the presence or absence as well as the type of the subscribed service, and the evaluation value determined by whether the being within the applicable period of the participated campaign. The priority setting unit 230 preferably sets the priority so that the difference between the least number of selection times and the number of selected times N during the past one month is greater than 0. When the difference between the least number of selection times and the number of selected times N is not greater than 0, the priority setting unit 230 may set the highest priority A regardless of the evaluation value of other items.

When selecting the electric storage system 18 that conducts power transmission and reception with the power grid 90, the selecting unit 220 refers to the priority included in the priority information stored in the storage unit 280 to select the electric storage system 18 that conducts power transmission and reception with the power grid 90. The selecting unit 220 selects the electric storage system 18 that conducts power transmission and reception with the power grid 90 based on the priority determined from the battery margin and the appliance margin and the priority included in the priority information described above.

In this embodiment, the battery 12 is regarded as the battery included in the vehicle 10. In another embodiment, the battery 12 may be a battery that is not included in the vehicle 10. For example, the battery 12 may be a stationary battery.

In the above-described embodiment, the operating time and the number of startups are illustrated as information indicating the deterioration state or usage of the electrical appliance 14, any information that may affect the durability or life of the electrical appliance 14 can be applied as the information indicating the deterioration state or usage of the electrical appliance 14.

The vehicle 10 may be an electric wheeled vehicle, including an electric vehicle, a hybrid vehicle and a saddle-riding wheeled vehicle such as an electric motorcycle. The vehicle 10 is one example of a moving object. The moving object may be any moving object with a battery other than a vehicle that travels on the land. The moving object may include aircraft such as an unmanned aerial vehicle (UAV), a ship and so on.

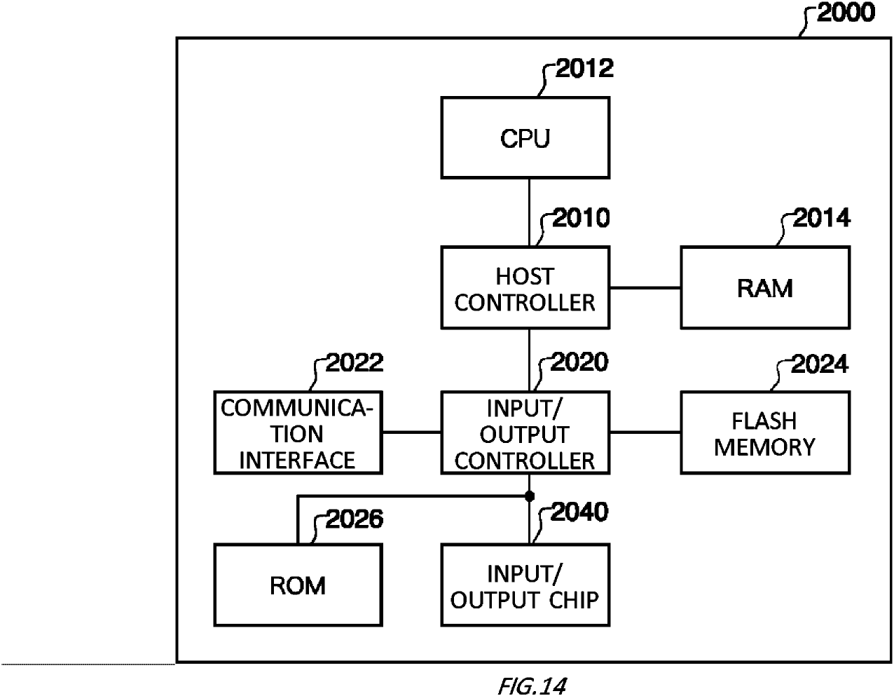

FIG. 14 shows an example of a computer 2000 in which a plurality of embodiments of the present invention may be entirely or partially embodied. A program installed on a computer 2000 may cause the computer 2000 to function as a system or each unit of the system, or an apparatus or each unit of the apparatus, such as the control apparatus 100, according to an embodiment, to perform operations associated with the system or each unit of the system or the apparatus or each unit of the apparatus, and/or to perform a process or a stage of a process according to an embodiment. Such a program may be executed by a CPU 2012 to cause the computer 2000 to perform certain operations associated with the processing procedures described herein and some of or all of the blocks in the block diagrams.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, thereby controlling each unit.

The communication interface 2022 communicates with other electronic devices via a network. The flash memory 2024 stores programs and data used by the CPU 2012 within the computer 2000. The ROM 2026 stores therein a boot program or the like executed by the computer 2000 at the time of activation, and/or a program depending on the hardware of the computer 2000. The input/output chip 2040 may connect various input/output units such as a keyboard, a mouse, and a monitor to the input/output controller 2020 via input/output ports such as a serial port, a parallel port, a keyboard port, a mouse port, a monitor port, a USB port, and a HDMI (registered trademark) port.

A program is provided via a network or computer readable storage media such as a CD-ROM, a DVD-ROM, or a memory card. The RAM 2014, the ROM 2026, or the flash memory 2024 is an example of the computer readable storage medium. Programs are installed in the flash memory 2024, the RAM 2014, or the ROM 2026 and executed by the CPU 2012. The information processing written in these programs is read by the computer 2000, and thereby cooperation between a program and the above-described various types of hardware resources is achieved. A device or method may be constituted by carrying out the operation or processing of information by using the computer 2000.

For example, when communication is carried out between the computer 2000 and an external device, the CPU 2012 may execute a communication program loaded onto the RAM 2014 to instruct communication processing to the communication interface 2022, based on the processing written in the communication program. The communication interface 2022, under control of the CPU 2012, reads transmission data stored on transmission buffering regions provided in recording media such as the RAM 2014 and the flash memory 2024, and transmits the read transmission data to a network and writes reception data received from a network to reception buffering regions or the like provided on the recording media.

In addition, the CPU 2012 may cause all or a necessary portion of a file or a database to be read into the RAM 2014, the file or the database having been stored in a recording medium such as the flash memory 2024, etc., and perform various types of processing on the data on the RAM 2014. The CPU 2012 may then write back the processed data to the recording medium.

Various types of information, such as various types of programs, data, tables, and databases, may be stored in the recording medium to undergo information processing. The CPU 2012 may perform various types of processing on the data read from the RAM 2014, which includes various types of operations, information processing, conditional judging, conditional branch, unconditional branch, search/replace of information, etc., as described herein and designated by an instruction sequence of programs, and writes the result back to the RAM 2014. In addition, the CPU 2012 may search for information in a file, a database, etc., in the recording medium. For example, when a plurality of entries, each having an attribute value of a first attribute associated with an attribute value of a second attribute, are stored in the recording medium, the CPU 2012 may search for an entry matching the condition such that the attribute value of the first attribute is designated, from among the plurality of entries, and read the attribute value of the second attribute stored in the entry, thereby acquiring the attribute value of the second attribute associated with the first attribute satisfying the predetermined condition.

The programs or software modules described above may be stored in the computer readable storage medium on the computer 2000 or in the vicinity of the computer 2000. A recording medium such as a hard disk or a RAM provided in a server system connected to a dedicated communication network or the Internet can be used as the computer readable storage media. A program stored in the computer readable storage medium may be provided to the computer 2000 via a network.

The program installed in the computer 2000 and causing the computer 2000 to function as the control apparatus 100 may instruct the CPU 2012 or the like to cause the computer 2000 to respectively function as each unit of the control apparatus 100. By being read by the computer 2000, the information processing described in these programs functions as each unit of the control apparatus 100 that is specific means as a result of the software and the above-described various types of hardware resources cooperating with each other. Then, these specific means implement operations or processing of information corresponding to the intended use of the computer 2000 in this embodiment, so that the control apparatus 100 is constructed as a specific information processing apparatus corresponding to the intended use.

Various embodiments have been described by referring to the block diagrams and the like. In the block diagram, each block may represent (1) a step of a process in which an operation is executed, or (2) each unit of the device having a role of executing the operation. Certain steps and sections may be implemented by dedicated circuitry, programmable circuitry supplied with computer readable instructions stored on computer readable storage media, and/or processors supplied with computer readable instructions stored on computer readable storage media. Dedicated circuit may include digital and/or analog hardware circuits and may include integrated circuits (IC) and/or discrete circuits. Programmable circuit may include reconfigurable hardware circuits including logical AND, logical OR, logical XOR, logical NAND, logical NOR, and other logical operations, flip-flops, registers, memory elements, etc., such as field-programmable gate arrays (FPGA), programmable logic arrays (PLA), etc.

Computer readable storage media may include any tangible device that can store instructions for execution by a suitable device, such that the computer readable storage medium having instructions stored therein forms at least a portion of an article of manufacture including instructions which can be executed to create means for performing processing operations or operations specified in the block diagrams. Examples of the computer readable storage medium may include an electronic storage medium, a magnetic storage medium, an optical storage medium, an electromagnetic storage medium, a semiconductor storage medium, and the like. More specific examples of the computer readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer readable instructions may be provided to a processor of a general purpose computer, special purpose computer, or other programmable data processing device, or to programmable circuit, locally or via a local area network (LAN), wide area network (WAN) such as the Internet, etc., to execute the computer readable instructions to provide means for performing described processing procedure or operations specified in the block diagrams. Examples of the processor include a computer processor, a processing unit, a microprocessor, a digital signal processor, a controller, a microcontroller, and the like.

While the embodiments of the present invention have been described, the technical scope of the invention is not limited to the above described embodiments. It is apparent to persons skilled in the art that various alterations and improvements can be added to the above-described embodiments. It is also apparent from the description of the claims that the embodiments to which such alterations or improvements are made can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

EXPLANATION OF REFRENCES

| | |
|---|---|
| 5 | System |
| 10 | Vehicle |
| 12 | Battery |
| 14 | Electrical appliance |
| 18 | Electric storage system |
| 20 | Control apparatus |
| 30 | Charging and Discharging facility |
| 42 | Dwelling unit |
| 44 | Facility |
| 70 | Power consumer |
| 80 | Power generation apparatus |
| 90 | Power grid |
| 100 | Control apparatus |
| 180 | Aggregator Server |
| 190 | Communication network |
| 200 | Processing unit |
| 210 | Acquisition unit |
| 220 | Selecting unit |
| 230 | Priority setting unit |
| 280 | Storage unit |
| 282 | Upper limit value storage unit |
| 290 | Communication unit |
| 2000 | Computer |
| 2010 | Host controller |
| 2012 | CPU |
| 2014 | RAM |
| 2020 | Input/output controller |
| 2022 | Communication interface |
| 2024 | Flash memory |
| 2026 | ROM |
| 2040 | Input/output chip |

What is claimed is:

1. A control apparatus, comprising:
an acquisition unit configured to acquire usage history of a plurality of electric storage systems that can conduct charging and discharging of electrical power with a power grid; and
a selecting unit configured to select, among the plurality of electric storage systems, an electric storage system that conducts power transmission and reception with the power grid,
wherein each of the plurality of electric storage systems includes a battery and an electrical appliance operating when conducting charging and discharging of the battery;
wherein the selecting unit specifies a deterioration state or usage of each of a plurality of the batteries and a deterioration state or usage of each of a plurality of the electrical appliances based on the usage history, and selects, among the plurality of electric storage systems, an electric storage system that conducts power transmission and reception with the power grid according to the deterioration state or usage of each of the plurality of batteries and the deterioration state or usage of each of the plurality of electrical appliances.

2. The control apparatus according to claim 1, wherein the selecting unit selects, among the plurality of electric storage systems, an electric storage system that conducts power transmission and reception with the power grid by conducting charging and discharging in a first manner, which largely affects deterioration of the plurality of electrical appliances, and an electric storage system that conducts power transmission and reception with the power grid by conducting charging and discharging in a second manner, which largely affects deterioration of the plurality of batteries.

3. The control apparatus according to claim 2, wherein the selecting unit gives more priority to an electric storage system including a battery with greater deterioration state or usage, and selects, among the plurality of electric storage systems, the electric storage system as an electric storage system that conducts power transmission and reception with the power grid by conducting charging and discharging in the first manner.

4. The control apparatus according to claim 2, wherein the selecting unit gives more priority to an electric storage system including an electrical appliance with greater deterioration state or usage, and selects, among the plurality of electric storage systems, the electric storage system as an electric storage system that conducts power transmission and reception with the power grid by conducting charging and discharging in the second manner.

5. The control apparatus according to claim 1, wherein when power resource provided by an electric storage system conducting power transmission and reception with the power grid is insufficient to a power resource required in the power grid, the selecting unit further selects, among the plurality of electric storage systems, an electric storage system including a battery with a deterioration degree or usage being equal to or greater than a predetermined first threshold and an electrical appliance with a deterioration degree or usage being equal to or greater than a second threshold, as an electric storage system that conducts power transmission and reception with the power grid.

6. The control apparatus according to claim 5, wherein the selecting unit does not select, among the plurality of electric storage systems, an electric storage system including a battery with a deterioration degree or usage being equal to or greater than a predetermined third threshold, or an electrical appliance with a deterioration degree or usage being equal to or greater than a fourth threshold, as an electric storage system that conducts power transmission and reception with the power grid.

7. The control apparatus according to claim 1, further comprising
an upper limit value storage unit configured to store an upper limit value of the deterioration degree or usage of each of the plurality of batteries at a predetermined time point, and an upper limit value of the deterioration degree or usage of each of the plurality of electrical appliances at the predetermined time point,
wherein the selecting unit
specifies, based on the deterioration degree or usage of each of the plurality of batteries and the upper limit value of the deterioration degree or usage of each of the plurality of batteries, a margin of the deterioration degree or usage of each of the plurality of batteries for the upper limit value of the deterioration degree or usage of each of the plurality of batteries;
specifies, based on the deterioration state or usage of each of the plurality of electrical appliances and the upper limit value of the deterioration degree or usage of each of the plurality of electrical appliances, a margin of the deterioration degree or usage of each of the plurality of electrical appliances for the upper limit value of the deterioration degree or usage of each of the plurality of electrical appliances; and
selects, among the plurality of electric storage systems, an electric storage system that conducts power transmission and reception with the power grid according to the margin of the deterioration degree or usage of each of the plurality of batteries and the margin of the deterioration degree or usage of each of the plurality of electrical appliances.

8. The control apparatus according to claim 1, wherein the selecting unit
specifies the deterioration state or usage of each of the plurality of batteries and the deterioration state or usage of each of the plurality of electrical appliances during a predetermined period; and
updates the deterioration state or usage of each of the plurality of batteries and the deterioration state or usage of each of the plurality of electrical appliances when the predetermined period elapses.

9. The control apparatus according to claim 1, wherein:
each electric storage system of the plurality of electric storage systems is provided in one corresponding moving object among a plurality of moving objects;
the control apparatus further comprises a priority setting unit configured to set a high priority to a moving object that satisfies a predetermined first condition rather than a moving object that does not satisfy the first condition among the plurality of moving objects;
the selecting unit is configured to give more priority and select, among a plurality of electric storage systems included in the plurality of moving objects, an electric storage system included in a moving object with the priority to be higher as an electric storage system that conducts power transmission and reception with the power grid.

10. The control apparatus according to claim 9, wherein the priority setting unit sets a high priority to a moving object associated with a user who is subscribed to a predetermined service related to the moving object, rather than a moving object associated with a user who is not subscribed to the predetermined service.

11. The control apparatus according to claim 9, wherein the priority setting unit sets a high priority to a moving object including an electric storage system such that the number of times of being selected, by the selecting unit during a predetermined period, as an electric storage system that conducts power transmission and reception with the power grid, is lower than a predetermined selection lower limit value, rather than a moving object including an electric storage system such that the number of times of being selected, by the selecting unit during a predetermined period, as an electric storage system that conducts power transmission and reception with the power grid, is equal to or greater than the selection lower limit value.

12. The control apparatus according to claim 9, wherein the priority setting unit sets a high priority to a moving object including an electric storage system such that the number of times of being selected, by the selecting unit during a predetermined period, as an electric storage system that conducts power transmission and reception with the power grid, is lower than a predetermined selection target value, rather than a moving object including an electric storage system such that the number of times of being selected, by the selecting unit during a predetermined period, as an electric storage system that conducts power transmission and reception with the power grid, is equal to or greater than the selection target value.

13. The control apparatus according to claim 9, wherein the priority setting unit further temporarily sets a high priority to a moving object that satisfies a predetermined second condition, which should be satisfied by a moving object with a temporarily set high priority, rather than a moving object that does not satisfy the second condition.

14. The control apparatus according to claim 13, wherein the priority setting unit temporarily sets a high priority to a moving object associated with a user who has participated in a predetermined temporary campaign rather than a moving object associated with a user who has not participated in the campaign.

15. The control apparatus according to claim 1, wherein each of the plurality of electric storage systems is provided in a corresponding moving object among a plurality of moving objects.

16. The control apparatus according to claim 15, wherein the moving object is a vehicle.

17. The control apparatus according to claim 3, wherein the selecting unit gives more priority to an electric storage system including an electrical appliance with greater deterioration state or usage, and selects, among the plurality of electric storage systems, the electric storage system as an electric storage system that conducts power transmission and reception with the power grid by conducting charging and discharging in the second manner.

18. The control apparatus according to claim 2, wherein when power resource provided by an electric storage system conducting power transmission and reception with the power grid is insufficient to a power resource required in the power grid, the selecting unit further selects, among the plurality of electric storage systems, an electric storage system including a battery with a deterioration degree or usage being equal to or greater than a predetermined first threshold and an electrical appliance with a deterioration degree or usage being equal to or greater than a second threshold, as an electric storage system that conducts power transmission and reception with the power grid.

19. A method, comprising:
acquiring a usage history of a plurality of electric storage systems that can conduct charging and discharging of electrical power with a power grid; and
selecting, among the plurality of electric storage systems, an electric storage system that conducts power transmission and reception with the power grid,
wherein each of the plurality of electric storage systems includes a battery and an electrical appliance that operates when conducting charging and discharging of the battery; and
the selecting, among the plurality of electric storage systems, an electric storage system that conducts power transmission and reception with the power grid specifying, based on the usage history, a deterioration state or usage of each of a plurality of the batteries and a deterioration state or usage of each of a plurality of the electrical appliances, and selects, among the plurality of electric storage systems, an electric storage system that conducts power transmission and reception with the power grid according to the deterioration state or usage of each of the plurality of batteries and the deterioration state or usage of each of the plurality of electrical appliances.

20. A computer readable storage medium, which is a non-transitory computer readable storage medium having a program stored therein, wherein the program causes a computer to function as:
an acquisition unit configured to acquire a usage history of a plurality of electric storage systems that can conduct charging and discharging of electrical power with a power grid; and
a selecting unit configured to select, among the plurality of electric storage systems, an electric storage system that conducts power transmission and reception with the power grid,
wherein each of the plurality of electric storage systems includes a battery and an electrical appliance operating when conducting charging and discharging of the battery;
wherein the selecting unit specifies a deterioration state or usage of each of a plurality of the batteries and a deterioration state or usage of each of a plurality of the electrical appliances based on the usage history, and selects, among the plurality of electric storage systems, an electric storage system that conducts power transmission and reception with the power grid according to the deterioration state or usage of each of the plurality of batteries and the deterioration state or usage of each of the plurality of electrical appliances.
